(19) United States
(12) Patent Application Publication
(10) Pub. No.: US 2022/0162939 A1
(43) Pub. Date: May 26, 2022

(54) CERAMIC WEAR PLATE

(71) Applicant: SANDVIK SRP AB, Svedala (SE)

(72) Inventor: Hodin ESBELANI, Trelleborg (SE)

(21) Appl. No.: 17/599,175

(22) PCT Filed: Mar. 29, 2019
(86) PCT No.: PCT/EP2019/058030

§ 371 Date: Sep. 28, 2021

(51) Int. Cl. E21C 35/04

(52) U.S. Cl. CPC E21C 35/04

(57) ABSTRACT

A ceramic wear plate includes a plurality of ceramic tiles embedded in rubber, the rubber enclosing the ceramic tiles in a plane of the ceramic wear plate such that lines of rubber strings are positioned between the ceramic tiles. The ceramic wear plate includes a number of first rubber strings extending in a first direction in the plane of the ceramic wear plate, a number of second rubber strings extending in a second direction in the plane, and a number of third rubber strings extending in a third direction in the plane. Each of the first second and third rubber strings extend in a continuous straight line between two different edges of the ceramic wear plate. The first, second and third directions are different directions and the edges extend in a direction parallel to the plane. A method of covering an area with the ceramic wear plates is also provided.

### FIELD OF INVENTION

The present invention relates to ceramic wear plates that are used for protecting surfaces from wear and impacts from objects, such as rocks in a mining equipment.

### BACKGROUND ART

In mining and construction applications and equipment, it is known to protect surfaces from wear and impact from objects by covering the surface with ceramic wear plates. The ceramic wear plates are resistant to impacts from objects and can be replaced by new ones when worn out or damaged.

A problem with covering a surface with ceramic wear plates is that often many of the ceramic wear plates have to be cut in some way to adapt them to the shape and size of the surface. In many cases, 20-30% of the ceramic wear plates have to be cut to adapt them to the surface and the cost for cutting or adapting the ceramic wear plates are a substantial part of the total cost.

There is thus a need for a way to reduce the costs for covering a surface with ceramic wear plates.

### SUMMARY OF THE INVENTION

An object of the present disclosure is to provide a ceramic wear plate, which seeks to mitigate, alleviate, or eliminate one or more of the above-identified deficiencies in the art and disadvantages singly or in any combination.

An object of the present disclosure is to provide a ceramic wear plate that reduces the complexity of cutting the ceramic wear plate when adapting the size and/or shape of the ceramic wear plate.

A further object of the present disclosure is to provide a ceramic wear plate that increases the possibility to adapt the shape and/or size of the ceramic wear plate without the need of cutting the actual ceramic tile(s) within the ceramic wear plate.

In this disclosure, a solution to the problem outlined above is proposed. In the proposed solution, a ceramic wear plate comprising a number of ceramic tiles embedded in rubber is disclosed. The rubber encloses the ceramic tiles in at least a plane of the ceramic wear plate and lines of rubber strings of the rubber are positioned between the ceramic tiles. The ceramic wear plate comprises a number of first rubber strings that extend in a first direction in the plane of the ceramic wear plate and in a continuous straight line between two different edges/ends of the ceramic wear plate.

The ceramic wear plate comprises a number of second rubber strings that extend in a second direction in the plane of the ceramic wear plate in a continuous straight line between two different edges/ends of the ceramic wear plate.

The ceramic wear plate comprises a number of third rubber strings that extend in a third direction in the plane of the ceramic wear plate in a continuous straight line between two different edges/ends of the ceramic wear plate.

The first, second and third directions are extending in different directions.

The edges are extending in directions that are parallel to the plane.

By the ceramic wear plate according to the above a ceramic wear plate is obtained, which shape and size can be adapted in many ways without or reducing the need of cutting or sawing in a ceramic tile. By adapting is meant that the shape and/or size of the ceramic wear plate is altered/changed. This will in turn reduce the adaptation costs of the ceramic wear plates since cutting or sawing in only rubber is much cheaper than cutting or sawing in rubber and ceramic tiles.

A further advantage is that it will reduce the time for adaptation of the ceramic wear plates since cutting or sawing in only rubber is much faster than cutting or sawing in rubber and ceramic tiles.

According to an aspect the ceramic wear plate comprises a number of fourth rubber strings that extend in a fourth direction in the plane of the ceramic wear plate in a continuous straight line between two different edges/ends of the ceramic wear plate and wherein the fourth direction is different to the first, second and third directions.

By having such a ceramic wear plate, it even further increases the possibilities of how the ceramic wear plate can be adjusted without the need to cut or saw the actual ceramic tile(s).

According to an aspect the first direction is perpendicular to the second direction and this will increase the different ways that the shape and size of the ceramic wear plate can be changed.

According to an aspect the third direction is perpendicular to the fourth direction, which increases the possibilities of how the size and shape of the ceramic wear plate can be changed.

According to an aspect the third direction extends at an angle of 40-50 degrees in relation to the first direction. According to an aspect the third direction extends at an angle of 45 degrees in relation to the first direction.

According to an aspect each of the rubber strings of the ceramic wear plate is either a first, second or third rubber string. By this, the size and the shape of the ceramic wear plate can be changed by cutting it in the space between several ceramic tiles.

According to an aspect each of the rubber strings of the ceramic wear plate is either a first, second, third or fourth rubber string. By this, the size and the shape of the ceramic wear plate can be changed by cutting it in the space between all ceramic tiles of the ceramic wear plate.

According to an aspect the ceramic tiles have a similar or the same shape. According to an aspect a plurality of the ceramic tiles has a similar or the equivalent shape as the other tiles. This obtains a regular pattern of rubber strings over the ceramic wear plate that in turn increases the possibility to change the size and shape of the ceramic wear plate.

According to an aspect the ceramic tiles have a triangular shape. According to an aspect the ceramic tiles have a hexagonal, octagonal or round shape.

According to an aspect the ceramic tiles have a right-angled triangular shape.

According to an aspect the right-angled triangular shaped ceramic tiles are grouped in groups of four ceramic tiles and each group of four ceramic tiles have a square shape. By this the shape and size of the ceramic wear plate can be changed along the length and width of the ceramic wear plate in addition to two different angled directions.

According to an aspect the ceramic wear plate comprises an integer number of groups of four ceramic tiles. By having an integer number of groups of ceramic tiles a regular pattern of rubber strings is obtained over the whole ceramic wear plate. By regular is meant a pattern that is repeated.

According to an aspect the right-angled point of the right-angled triangular shaped ceramic tile is facing a centre of the group of four ceramic wear plates.

According to an aspect the ceramic wear plate has a rectangular shape. According to an aspect the ceramic wear plate has a square or a triangular shape.

According to an aspect the number of first, second, third or fourth rubber strings are at least two. According to an aspect the number of first, second, third or fourth rubber strings are at least three. According to an aspect the number of first, second, third or fourth rubber strings are at least four.

In this disclosure, a further solution to the problem outlined above is proposed. In the proposed solution, a method of covering an area with ceramic wear plates according to the above is disclosed. The method comprises the steps of obtaining the dimensions of the area, adapting the shape of at least one ceramic wear plate by cutting or sawing it along the first, second, third or fourth rubber string, and connecting the ceramic wear plates to the area.

Generally, all terms used in the claims are to be interpreted according to their ordinary meaning in the technical field, unless explicitly defined otherwise herein. All references to “a/an/the [element, device, component, means, etc.]” are to be interpreted openly as referring to at least one instance of said element, device, component, means, etc., unless explicitly stated otherwise. Further, by the term “comprising” it is meant “comprising but not limited to” throughout the application.

### BRIEF DESCRIPTION OF THE DRAWINGS

The foregoing will be apparent from the following more particular description of the example embodiments and aspects, as illustrated in the accompanying drawings in which like reference characters refer to the same parts throughout the different views. The drawings are not necessarily to scale, emphasis instead being placed upon illustrating the example embodiments and aspects.

FIG. 1 discloses a schematic perspective view from above of a ceramic wear plate according to an aspect of the invention.

FIG. 2 discloses a schematic view from above of the ceramic wear plate in FIG. 1.

FIG. 3 discloses a schematic perspective view from below of a ceramic wear plate according to an aspect of the invention.

FIG. 4 discloses a schematic side view of a ceramic wear plate according to an aspect of the invention.

FIG. 5 discloses a schematic view from above of a ceramic wear plate according to an aspect of the invention.

FIG. 6 discloses a schematic view from above of a ceramic wear plate according to an aspect of the invention after the shape has been adapted.

### DETAILED DESCRIPTION OF PREFERRED EMBODIMENT OF THE INVENTION

Aspects and embodiments of the present disclosure will be described more fully hereinafter with reference to the accompanying figures. The assembly disclosed herein can, however, be realized in many different forms and should not be construed as being limited to the aspects set forth herein.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The present invention relates to the field of protecting a surface or area in a mining equipment, application or similar by covering the surface with a number of ceramic wear plates. The ceramic wear plates are connected to the surface in a pattern such that it covers the whole surface or an area of the surface. Many of the ceramic wear plates often needs to be adapted to cover the area or the whole surface or surfaces. The ceramic wear plates are cut by a specific saw or water cutting jet to adapt the shape and/or size of the ceramic wear plate to an intended position on the surface. The surface can be any surface that needs protection from objects, such as rocks, hitting it and/or sliding on it. To use ceramic wear plates as such to protect a surface is well known in the art and will thus not be described further herein.

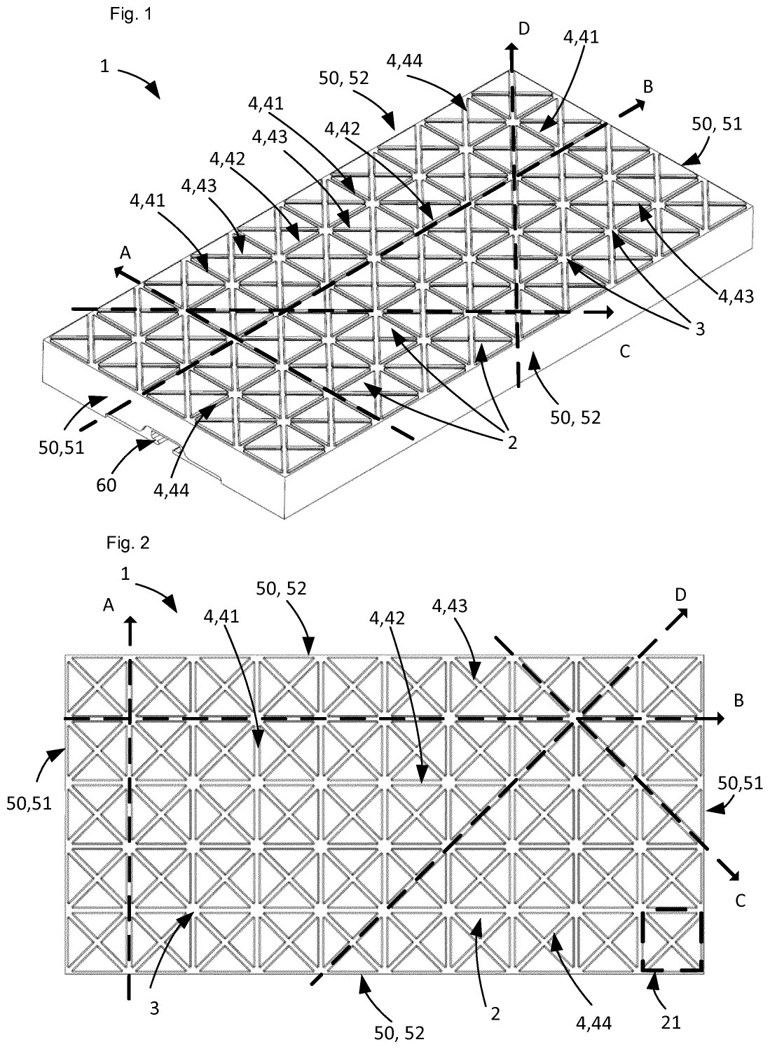

In FIGS. 1 and 2, to which now is referred to, a ceramic wear plate 1 according to an aspect of the invention is disclosed. The ceramic wear plate 1 is in the following described in an uncut state. Put in another way, the ceramic wear plate 1 is described as it looks before the shape and/or size of it has been changed or adapted unless otherwise stated.

The ceramic wear plate 1 comprises a plane. The plane comprises the surface of the ceramic wear plate 1 that is intended to be directed away from the surface that the ceramic wear plate should protect.

According to an aspect the ceramic wear plate 1 has a rectangular shape. According to an aspect the ceramic wear plate 1 has a square shape. According to an aspect the ceramic wear plate 1 has a triangular shape.

The ceramic wear plate 1 comprises a number of edges 50. The edges 50 are located or positioned at or along a circumference of the ceramic wear plate 1. The number of edges 50 depend on the shape of the ceramic wear plate 1. According to an aspect the edges are a board or part of a frame. The ceramic wear plate 1 disclosed in FIGS. 1 and 2 has a rectangular shape and comprises four edges 50, two short side edges 51 that extends along the width of the ceramic wear plate 1 and two long side edges 52 that extends along the length of the ceramic wear plate 1. The edges 50, 51, 52 extends in a direction that is parallel to the plane of the ceramic wear plate 1. According to an aspect the edges 50, 51, 52 extends in the plane of the ceramic wear plate 1. According to an aspect the shape of the ceramic wear plate 1 is triangular and then it comprises three edges 50. According to an aspect the shape of the ceramic wear plate 1 is pentagonal and then it comprises five edges 50, etc.

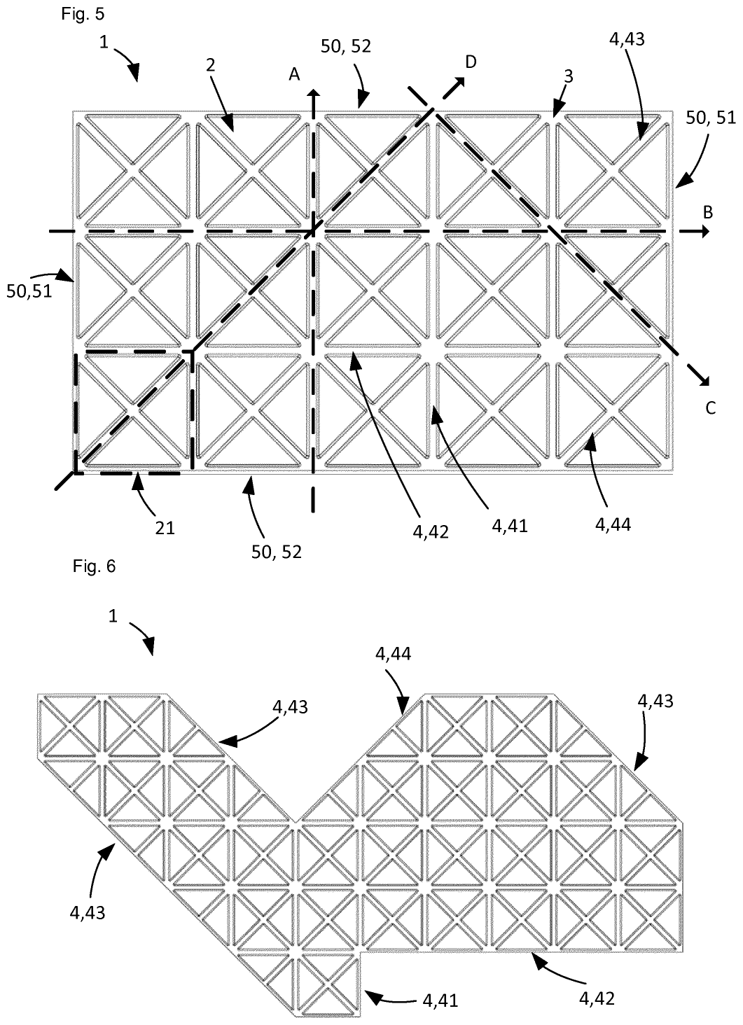

The ceramic wear plate 1 comprises a number of ceramic tiles 2 and rubber 3. The actual number of ceramic tiles 2 are dependent of the size and dimensions of the ceramic tiles and the dimensions and size of the ceramic wear plate 1. According to an aspect, as is disclosed in FIGS. 1 and 2, the ceramic wear plate 1 comprises 200 ceramic tiles 2. According to an aspect, as is disclosed in FIG. 5, the ceramic wear plate 1 comprises 60 ceramic tiles 2. The invention as such is not limited to a specific number of ceramic tiles 2, rather this is dependent on the size of the ceramic wear plate 1 and the location that it should be mounted at.

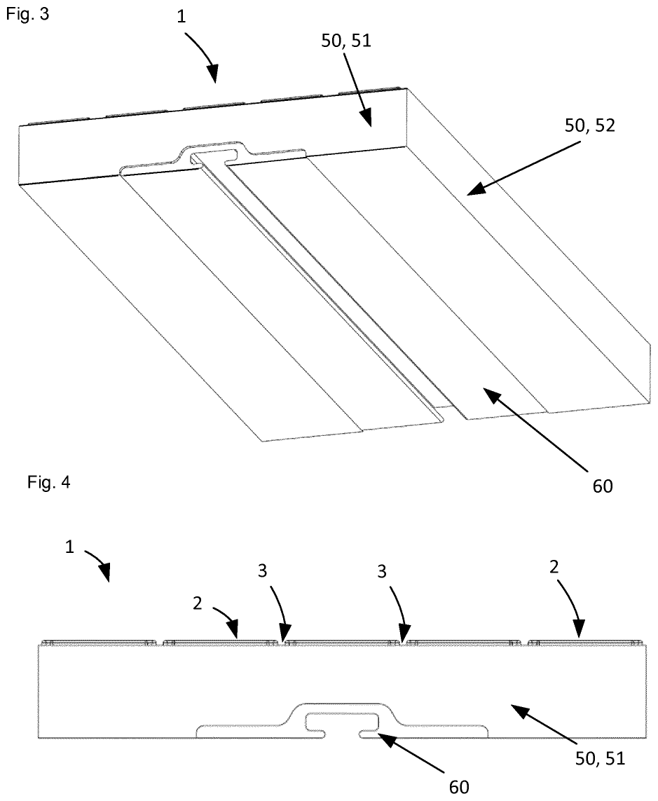

According to an aspect the edges 50, 50, 52 of the ceramic wear plate 1 form a frame that encloses the ceramic tiles 2 and the rubber 3. According to an aspect the ceramic wear plate 1 comprises a mounting connection 60 that is configured to interact with a connection on the surface to connect the ceramic wear plate 1 to the surface. The mounting connection 60 is further disclosed in FIGS. 3 and 4. The mounting connection 60 is located on the side of the ceramic wear plate 1 that is intended to be faced towards the surface that it should protect.

According to an aspect a plurality of the ceramic tiles 2 has a similar or the equivalent shape as the other tiles 2. According to an aspect the shape of the ceramic tiles 2 of the ceramic wear plate 1 is the same. Put in another way the ceramic tiles 2 of a ceramic wear plate 1 have a similar shape. According to an aspect the size of the ceramic tiles 2 of the ceramic wear plate 1 is the same. Put in another way the ceramic tiles 2 of a ceramic wear plate 1 have a similar size. According to an aspect the shape of the ceramic tiles 2 of different ceramic wear plates 1 is different. According to an aspect the ceramic tiles 2 have a triangular shape. According to an aspect the ceramic tiles 2 have a hexagonal shape. According to an aspect the ceramic tiles 2 have an octagonal shape. According to an aspect the ceramic tiles 2 have a round shape.

According to an aspect, as disclosed in FIGS. 1, 2 and 5, the ceramic tiles 2 have a right-angled triangular shape. Put in another way, the shape of the ceramic tiles 2 is a right-angled triangular shape.

According to an aspect the ceramic tiles are grouped in groups 21 of four ceramic tiles 2. According to an aspect the right-angled triangular shaped ceramic tiles 2 are grouped in groups 21 of four ceramic tiles 2. According to an aspect each group 21 of four ceramic tiles 2 have a square shape, as is disclosed in FIGS. 2 and 5. Put in another way, the base of the triangular shape of each of the four triangular ceramic tiles 2 constitutes a side of the square shaped group 21.

According to an aspect the right-angled point of the right-angled triangular shaped ceramic tile 2 is facing a centre of the group 21 of four ceramic tiles 2. Put in another way the right-angled tip of the ceramic tile 2 is facing inwards in the group 21.

According to an aspect the ceramic wear plate 1 comprises an integer number of groups 21 of ceramic tiles 2. According to an aspect the ceramic wear plate 1 comprises an integer number of groups 21 of four ceramic tiles 2.

The shape and the size of the ceramic tiles 2 described above are described with reference to the plane of the ceramic wear plate 1 and in the direction that is intended to be faced away from the surface that it should protect.

According to an aspect the ceramic tiles 2 are embedded in the rubber 3. The rubber 3 encloses the ceramic tiles 2 in at least a plane of the ceramic wear plate 1. The ceramic tiles 2 extend above the rubber 3 in the direction of the ceramic wear plate 1 that is intended to be directed away from the surface that it should protect, as is disclosed in FIG. 4. By this, objects that hit and/or slides on the ceramic wear plate 1 first hit and/or slides on the ceramic tiles 2 and not the softer rubber 3. Lines of rubber strings 4 of the rubber 3 are positioned between the ceramic tiles 2. Put in another way the rubber 3 is positioned between the ceramic tiles 2 and fill a gap between the ceramic tiles 2. The rubber 3 between the ceramic tiles 2 constitutes lines of rubber, i.e. the rubber strings 4, that extend between several ceramic tiles 2.

According to an aspect the ceramic wear plate 1 comprises a number of first rubber strings 41. According to an aspect the ceramic wear plate 1 comprises a number of second rubber strings 42. According to an aspect the ceramic wear plate 1 comprises a number of third rubber strings 43. According to an aspect the ceramic wear plate 1 comprises a number of fourth rubber strings 44.

The first rubber strings 41 extend in a first direction A. The first direction extend in the plane of the ceramic wear plate 1. The first rubber strings 41 extend in a continuous substantial straight line between two different edges 50 of the ceramic wear plate 1. Put in another way the first rubber strings 41 extend from one edge 50 of the ceramic wear plate 1 to another edge 50 of the ceramic wear plate 1. The first rubber strings 41 extend across the complete ceramic wear plate 1 from one edge 50 to another edge 50. According to an aspect the number of first rubber strings 41 extend in the first direction A in the plane of the ceramic wear plate 1 and in a continuous substantial straight line between two different edges 50 of the ceramic wear plate 1. According to an aspect, as is disclosed in FIGS. 1, 2 and 5, the first rubber strings 41 extends between two opposite long side edges 52 of the ceramic wear plate 1. According to an aspect each first rubber string 41 extends from one long side edge 52 to the opposite long side edge 52. According to an aspect the first rubber strings 41 extends in the width of the ceramic wear plate 1.

The second rubber strings 42 extend in a second direction B. The second direction B extends in the plane of the ceramic wear plate 1. The second rubber strings 42 extend in a continuous substantial straight line between two different edges 50 of the ceramic wear plate 1. Put in another way the second rubber strings 42 extend from one edge 50 of the ceramic wear plate 1 to another edge 50 of the ceramic wear plate 1. The second rubber strings 42 extend across the whole/complete ceramic wear plate 1 from one edge 50 to another edge 50. According to an aspect the number of second rubber strings 42 extend in the second direction B in the plane of the ceramic wear plate 1 and in a continuous substantial straight line between two different edges 50 of the ceramic wear plate 1. According to an aspect, as is disclosed in FIGS. 1, 2 and 5, the second rubber strings 42 extends between two opposite short side edges 51 of the ceramic wear plate 1. According to an aspect each second rubber string 42 extends from one short side edge 51 to the opposite short side edge 51. According to an aspect the second rubber strings 42 extends in the length of the ceramic wear plate 1.

The third rubber strings 43 extend in a third direction C. The third direction C extends in the plane of the ceramic wear plate 1. The third rubber strings 43 extends in a continuous substantial straight line between two different edges 50 of the ceramic wear plate 1. Put in another way the third rubber strings 43 extend from one edge 50 of the ceramic wear plate 1 to another edge 50 of the ceramic wear plate 1. The third rubber strings 43 extend across the complete ceramic wear plate 1 from one edge 50 to another edge 50. According to an aspect the number of third rubber strings 43 extend in the third direction C in the plane of the ceramic wear plate 1 and in a continuous substantial straight line between two different edges 50 of the ceramic wear plate 1. According to an aspect, as is disclosed in FIGS. 1, 2 and 5, some of the third rubber strings 43 extends between one short side edge 51 and one long side edge 52 of the ceramic wear plate 1 and some of the third rubber strings 43 extends between two opposite long side edges 52. According to an aspect each third rubber string 43 extends from either one short side edge 51 to one long side edge 52 or between two opposite long side edges 52.

According to an aspect each of the rubber strings 4 of the ceramic wear plate is either a first, second or third rubber string 41, 42, 43.

According to an aspect the first, second and third directions A, B, C are different directions. Put in another way the first direction A is a direction that extends in a direction that is different compared to the direction that the second direction B extended in and is different from the direction that the third direction C extended in. The first, second and third directions A, B, C are all directions that are parallel to the plane of the ceramic wear plate 1. According to an aspect the first direction A is perpendicular to the second direction B. According to an aspect the first direction A extends across the width of the ceramic wear plate 1 as is disclosed in FIGS. 1 and 2. Put in another way the first direction A extends across the ceramic wear plate 1 from one long side edge 52 to the other long side edge 52. According to an aspect the second direction B extends along in the length of the rectangular shaped ceramic wear plate 1 as is disclosed in FIGS. 1 and 2. Put in another way the second direction B extends across the ceramic wear plate 1 from one short side edge 51 to the other short side edge 51. Put in another way the second direction B extends along the lengthwise direction of the rectangular shaped ceramic wear plate 1.

According to an aspect the third direction C extends at an angle of 40-50 degrees in relation to the first direction A. According to an aspect the third direction C extends at an angle of 45 degrees in relation to the first direction A.

According to an aspect the third direction C extends at an angle of 40-50 degrees in relation to the second direction B. According to an aspect the third direction C extends at an angle of 45 degrees in relation to the second direction B.

According to an aspect the third direction C extends at an angle of 40-50 degrees in relation to the first and second direction A and B. According to an aspect the third direction C extends at an angle of 45 degrees in relation to the first and second directions A and B.

According to an aspect the fourth rubber strings 44 extend in a fourth direction D. The fourth direction D extends in the plane of the ceramic wear plate 1. The fourth rubber strings 44 extends in a continuous substantial straight line between two different edges 50 of the ceramic wear plate 1. Put in another way the fourth rubber strings 44 extend from one edge 50 of the ceramic wear plate 1 to another edge 50 of the ceramic wear plate 1. The fourth rubber strings 44 extend across the whole ceramic wear plate 1 from one edge 50 to another edge 50. According to an aspect the number of fourth rubber strings 44 extend in the fourth direction D in the plane of the ceramic wear plate 1 and in a continuous substantial straight line between two different edges 50 of the ceramic wear plate 1. According to an aspect as is disclosed in FIGS. 1,2 and 5, some of the fourth rubber strings 44 extends between one short side edge 51 and one long side edge 52 of the ceramic wear plate 1 and some of the fourth rubber strings 44 extends between two opposite long side edges 52. According to an aspect each fourth rubber string 44 extends from either one short side edge 51 to one long side edge 52 or between two opposite long side edges 52.

According to an aspect each of the rubber strings 4 of the ceramic wear plate 1 is either a first, second, third or fourth rubber string 41, 42, 43, 44.

According to an aspect the fourth direction D is different from the first, second and third directions A, B, C. The first, second, third and fourth directions A, B, C, D are all parallel to the plane of the ceramic wear plate 1. According to an aspect the third direction C is perpendicular to the fourth direction D.

According to an aspect the fourth direction D extends at an angle of 40-50 degrees in relation to the first direction A. According to an aspect the fourth direction D extends at an angle of 45 degrees in relation to the first direction A.

According to an aspect the fourth direction D extends at an angle of 40-50 degrees in relation to the second direction B. According to an aspect the fourth direction D extends at an angle of 45 degrees in relation to the second direction B.

According to an aspect the fourth direction D extends at an angle of 40-50 degrees in relation to the first and second directions A, B. According to an aspect the fourth direction D extends at an angle of 45 degrees in relation to the first and second directions A, B.

According to an aspect the number of first, second, third or fourth rubber strings 41, 42, 43, 44 is at least two or more. According to an aspect the number of first rubber strings 41 is at least two or more. According to an aspect the number of second rubber strings 42 is at least two or more. According to an aspect the number of third rubber strings 43 is at least two or more. According to an aspect the number of fourth rubber strings 44 is at least two or more. According to an aspect the number of rubber strings 4 depends on the number of ceramic tiles 2 of the ceramic wear plate 1.

According to an aspect the number of first, second, third or fourth rubber strings 41, 42, 43, 44 are at least three. According to an aspect the number of first, second, third or fourth rubber strings 41, 42, 43, 44 are at least four.

According to an aspect all rubber strings 4 of the ceramic wear plate 1 in the first direction A are first rubber strings 41. According to an aspect all rubber strings 4 of the ceramic wear plate 1 in the second direction B are second rubber strings 42. According to an aspect all rubber strings 4 of the ceramic wear plate 1 in the third direction C are third rubber strings 43. According to an aspect all rubber strings 4 of the ceramic wear plate 1 in the fourth direction D are fourth rubber strings 44.

The size and shape of the ceramic wear plate 1 can be adapted by cutting or sawing along any of the first, second, third or fourth rubber strings 41, 42, 43, 44. As the first, second, third or fourth rubber strings 41, 42, 43, 44 extend between two different edges 50 of the ceramic wear plate 1, the size and shape of the ceramic wear plate 1 can be altered without any need of cutting or sawing in a ceramic tile 2.

According to an aspect and if the ceramic wear plate 1 in FIG. 2 is too long, the ceramic wear plate 1 can be shortened by cutting or sawing it along any of the first rubber strings 41. The ceramic wear plate 1 can be shortened in steps of the distance between two adjacent first rubber strings 41.

According to an aspect and if the ceramic wear plate 1 in FIG. 2 is too wide, the ceramic wear plate 1 can be shortened by cutting or sawing it along any of the second rubber strings 42. The width of the ceramic wear plate 1 can be reduced in steps of the distance between two adjacent second rubber strings 42.

According to an aspect, as is disclosed in FIG. 6, the size and shape of the ceramic wear plate 1 could be adapted in many ways by cutting it along any of the first, second, third or fourth rubber strings 41, 42, 43, 44. The ceramic wear plate 1 in FIG. 6 has a rectangular shape and the ceramic wear tiles 2 has a triangular shape. According to an aspect the size and shape of the ceramic wear plate 1 could be adapted by cutting or sawing it only along parts of the first, second, third or fourth rubber strings 41, 42, 43, 44 between two edges, as is disclosed in FIG. 6. A bottom left corner of the ceramic wear plate 1 has been removed by cutting along one of the third rubber strings 43 that extends from one short side edge 51 to one long side edge 52. A upper right corner of the ceramic wear plate 1 has been removed by cutting along one of the third rubber strings 43 that extends from the other long side edge 52 to the other short side edge 52. A triangular shaped part has been removed from the ceramic wear plate 1 by cutting it in one of the third rubber strings 43 and in one of the fourth rubber strings 44 that cross the third rubber string 43. A rectangular part of a right bottom corner has been removed by cutting in one of the first rubber strings 41 and in one of the second rubber strings 42 that cross the first rubber string 41.

Hereafter a method of covering an area with ceramic wear plates 1 according to an aspect will be described. The method comprising the steps of obtaining a dimension of the area. This could be done by measuring the area or from a drawing. A pattern of ceramic wear plates 1 is thereafter determined based on minimizing the number of ceramic wear plates 1 that needs to be adapted. The pattern of the ceramic wear plates 1 that needs to be adapted is thereafter optimized to maximize the number of ceramic wear plates 1 that only have to be adapted by cutting along or in the first, second, third or fourth rubber string 41, 42, 43, 44. The shape of the ceramic wear plates 1 are thereafter adapted by cutting it along the first, second, third and/or fourth rubber string 41, 42, 43, 44. Thereafter the ceramic wear plates 1 are connected to the area or surface that should be protected.

The person skilled in the art realizes that the present invention by no means is limited to the preferred embodiments described above. On the contrary, many modifications and variations are possible within the scope of the appended claims. For example, a sliding door set may comprise of more than two sliding door leafs, arranged in the same way as discussed above.

The description of the aspects of the disclosure provided herein has been presented for purposes of illustration. The description is not intended to be exhaustive or to limit aspects of the disclosure to the precise form disclosed, and modifications and variations are possible in light of the above teachings or may be acquired from practice of various alternatives to the provided aspects of the disclosure. The examples discussed herein were chosen and described in order to explain the principles and the nature of various aspects of the disclosure and its practical application to enable one skilled in the art to utilize the aspects of the disclosure in various manners and with various modifications as are suited to the particular use contemplated. The features of the aspects of the disclosure described herein may be combined in all possible combinations of methods, apparatus, modules, systems, and computer program products. It should be appreciated that the aspects of the disclosure presented herein may be practiced in any combination with each other.

It should be noted that the word “comprising” does not necessarily exclude the presence of other elements or steps than those listed. It should further be noted that any reference signs do not limit the scope of the claims.

1. A ceramic wear plate having a plurality of ceramic tiles embedded in rubber, wherein the rubber encloses the ceramic tiles in at least a plane of the ceramic wear plate and lines of rubber strings of the rubber are positioned between the ceramic tiles, the ceramic wear plate comprising:
a number of first rubber strings that extend in a first direction in the plane of the ceramic wear plate and in a continuous straight line between two different edges of the ceramic wear plate;
a number of second rubber strings that extend in a second direction in the plane of the ceramic wear plate in a continuous straight line between the two different edges of the ceramic wear plate; and
a number of third rubber strings that extend in a third direction in the plane of the ceramic wear plate in a continuous straight line between the two different edges of the ceramic wear plate, wherein the first, second and third directions are extending in different directions and the two different edges are extending in directions that are parallel to the plane.

2. The ceramic wear plate according to claim 1, further comprising a number of fourth rubber strings that extend in a fourth direction in the plane of the ceramic wear plate in a continuous straight line between the two different edges of the ceramic wear plate, wherein the fourth direction is different from the first, second and third directions.

3. The ceramic wear plate according to claim 1, wherein the first direction is perpendicular to the second direction.

4. The ceramic wear plate according to claim 2, wherein the third direction is perpendicular to the fourth direction.

5. The ceramic wear plate according to claim 1, wherein the third direction extends at an angle of 40-50 degrees in relation to the first direction.

6. The ceramic wear plate according to claim 1, wherein each of the lines of rubber strings of the ceramic wear plate is either a first, second or third rubber string.

7. The ceramic wear plate according to claim 2, wherein each of the lines of rubber strings of the ceramic wear plate is either a first, second, third or fourth rubber string.

8. The ceramic wear plate according to claim 1, wherein the plurality of the ceramic tiles each has a similar or equivalent shape.

9. The ceramic wear plate according to claim 1, wherein each of the plurality of ceramic tiles has a triangular shape.

10. The ceramic wear plate according to claim 1, wherein each of the plurality of ceramic tiles has a right-angled triangular shape.

11. The ceramic wear plate according to claim 10, wherein the right-angled triangular shaped ceramic tiles are grouped in groups of four ceramic tiles and each group of four ceramic tiles form a square shape.

12. The ceramic wear plate according to claim 11, wherein a right-angled point of the right angled triangular shaped ceramic tile faces a centre of the group of four ceramic tiles.

13. The ceramic wear plate according to claim 1, wherein the ceramic wear plate has a rectangular, a square or a triangular shape.

14. The ceramic wear plate according to any of claim 2, wherein the number of first, second, third or fourth rubber strings is at least two.

15. A method of covering an area with a plurality of ceramic wear plates according to claim 1, comprising the steps of:
obtaining dimensions of the area;
arranging a shape of at least one ceramic wear plate of the plurality of ceramic wear plates by cutting the at least one ceramic wear plate along the first, second, third or fourth rubber string; and
connecting the plurality of ceramic wear plates to form the area.
